(19) United States
(12) Patent Application Publication
(10) Pub. No.: US 2025/0265152 A1
(43) Pub. Date: Aug. 21, 2025

(54) SEMICONDUCTOR CHIP OF CORRECTING ALIGNED ERROR AND SEMICONDUCTOR SYSTEM OF CORRECTING ALIGNED ERROR

(71) Applicant: Research & Business Foundation Sungkyunkwan University, Suwon-si (KR)

(72) Inventors: Jungrae KIM, Seoul (KR); Yu Jin LIM, Suwon-si (KR)

(73) Assignee: Research & Business Foundation Sungkyunkwan University, Suwon-si (KR)

(21) Appl. No.: 19/049,202

(22) Filed: Feb. 10, 2025

(30) Foreign Application Priority Data
Feb. 15, 2024 (KR) 10-2024-0022039

(51) Int. Cl. G06F 11/10

(52) U.S. Cl. CPC G06F 11/1068; G06F 11/1048

(57) ABSTRACT

The present invention provides a semiconductor chip and system that efficiently corrects single-cell errors in multi-level cell (MLC) memory by utilizing a novel error correction code (SCC) with optimized parity check matrix construction, enabling correction of all single-cell errors while maintaining the same or fewer redundancy bits compared to conventional error correction codes.

### CROSS-REFERENCE TO RELATED APPLICATION

This application claims the benefit of Korea Patent Application No. 10-2024-0022039 filed on Feb. 15, 2024, which are incorporated herein by reference for all purposes as if fully set forth herein.

### BACKGROUND

### Field

The embodiment relates to a semiconductor chip for correcting aligned errors and a semiconductor system for correcting aligned errors. More specifically, it relates to error correction code (ECC) for detecting error locations and correcting errors in semiconductors and systems.

### Description of Related Art

Error correction code (ECC) generates a codeword through an encoding process on data to be transmitted, and when decoding, detects error locations in the received codeword to correct errors. ECC is used not only for communication but also to protect data being read from and written to memory. Since ECCs that guarantee high reliability require increased redundancy bits and increased time, power consumption, and area burden for encoding/decoding, an appropriate ECC method is selected considering these factors.

Single error correction (SEC) code is a code capable of correcting a single error that occurs in a codeword. The properties of a parity check matrix satisfying this have two main characteristics. First, all columns in the parity check matrix are non-zero. Second, all columns in the parity check matrix are different from each other. Single error correction code has low area overhead and low encoding/decoding complexity, but since it can only correct single errors, it does not guarantee strong protection.

Single error correction-double error detection (SEC-DED) code is a code that can correct single errors and detect but not correct double errors when they occur in a codeword. Although it can detect all double errors, it requires more redundancy bits than single error correction code and its error correction capability is still limited to single errors.

Single error correction-double adjacent error correction (SEC-DAEC) code is a code that can correct single errors or two adjacent errors when they occur in a codeword. In 4LC memory where one cell stores two bits, it can correct all single cell errors, but requires more redundancy bits than single error correction code. Additionally, it has the disadvantage that it cannot correct all single cell errors in 8LC memory where one cell stores three or more bits.

Single error correction-double adjacent error correction-triple adjacent error correction (SEC-DAEC-TAEC) code is a code that can correct single errors, two adjacent errors, or three adjacent errors when they occur in a codeword. However, this code cannot correct double errors when they occur non-adjacently among single cell errors that can occur in 8LC memory storing three or more bits.

### PRIOR ART DOCUMENTS

### Patent Documents

(Patent Document 1) Korean Patent Publication No. 10-2007-0104138 (2007 Oct. 25) “Method of Encoding Using Parity Check Matrix”

### SUMMARY

The embodiment aims to propose an SCC error correction code that can correct all single cell errors that can occur in MLC (multi-level cell) memory.

Existing error correction codes have insufficient error correction capability when used in MLC memory, or burden storage space by using too many redundancy bits compared to their correction capability.

The embodiment aims to provide an error correction code that can efficiently protect memory from single cell errors, which account for most of the errors in MLC memory.

According to one embodiment, a semiconductor chip for correcting errors comprises an encoder logic circuit configured to acquire data and encode the acquired data by multiplying a pre-generated error correction code's generator matrix with the acquired data; a memory configured to receive encoded data, store two or more bits of data in one memory cell, and read out modified data where the encoded data has been modified by operating environment; and a logic circuit configured to acquire the modified data and correct single or multiple errors within a single cell of the modified data using the error correction code's parity check matrix.
Wherein for 4LC memory, the error correction code has 64 bits of original data bits and 7 check bits, and is configured to correct single or double errors within a single cell.
wherein for 8LC memory, the error correction code has 64 bits of original data bits and 8 check bits, and is configured to correct single, double, or triple errors within a single cell.
wherein the error correction code is generated by: setting columns corresponding to the number of check bits from the rightmost end of the parity check matrix as an identity matrix, when the number of check bits is n, selecting one primitive polynomial among multiple primitive polynomials of Galois field (GF) GF(2n), sequentially assigning consecutive elements in the Galois field defined by the selected primitive polynomial from the left columns of the identity matrix, when an added column obtained by summing multiple columns within a single cell among the already assigned cells overlaps with an element to be assigned during the sequential assignment of consecutive elements, providing a certain interval and resuming the sequential assignment of consecutive elements, and generating the error correction code's parity check matrix and generator matrix based on the assignment process.

According to another embodiment, a semiconductor system for correcting errors includes a memory chip configured to receive encoded data, store two or more bits of data in one memory cell, and read out modified data where the encoded data has been modified by the memory's operating environment, a control chip configured to control the memory chip, wherein the control chip includes an encoder logic circuit configured to acquire data and encode the acquired data by multiplying a pre-generated error correction code's generator matrix with the acquired data and store the encoded data in the memory chip; and a logic circuit configured to acquire the modified data from the memory chip and correct single or multiple errors within a single cell of the modified data using the error correction code's parity check matrix.
wherein for 4LC memory, the error correction code has 64 bits of original data bits and 7 check bits, and is configured to correct single or double errors within a single cell.
wherein for 8LC memory, the error correction code has 64 bits of original data bits and 8 check bits, and is configured to correct single, double, or triple errors within a single cell.
wherein the error correction code is generated by: setting columns corresponding to the number of check bits from the rightmost end of the parity check matrix as an identity matrix, when the number of check bits is n, selecting one primitive polynomial among multiple primitive polynomials of Galois field (GF) GF(2n), sequentially assigning consecutive elements in the Galois field defined by the selected primitive polynomial from the left columns of the identity matrix, when an added column obtained by summing multiple columns within a single cell among the already assigned cells overlaps with an element to be assigned during the sequential assignment of consecutive elements, providing a certain interval and resuming the sequential assignment of consecutive elements, and generating the error correction code's parity check matrix and generator matrix based on the assignment process.

According to another embodiment, a semiconductor chip for correcting errors includes a transceiver configured to receive modified data where data and encoded data have been modified through communication, and transmit encoded data and decoded data; an encoder logic circuit configured to multiply the data with a pre-generated error correction code's generator matrix to generate the encoded data; and a logic circuit configured to correct single or multiple errors within a single cell boundary of the modified data using the error correction code's parity check matrix.
wherein for 4LC memory, the error correction code has 64 bits of original data bits and 7 check bits, and is configured to correct single or double errors within a single cell boundary.
wherein for 8LC memory, the error correction code has 64 bits of original data bits and 8 check bits, and is configured to correct single, double, or triple errors within a single cell boundary.
wherein the error correction code is generated by: setting columns corresponding to the number of check bits from the rightmost end of the parity check matrix as an identity matrix, when the number of check bits is n, selecting one primitive polynomial among multiple primitive polynomials of Galois field (GF) GF(2n), sequentially assigning consecutive elements in the Galois field defined by the selected primitive polynomial from the left columns of the identity matrix, when an added column obtained by summing multiple columns within a single cell among the already assigned cells overlaps with an element to be assigned during the sequential assignment of consecutive elements, providing a certain interval and resuming the sequential assignment of consecutive elements, and generating the error correction code's parity check matrix and generator matrix based on the assignment process.

According to the embodiment, while maintaining the same number of redundancy bits as existing error correction codes, an error correction code that can correct all single cell errors that can occur in MLC memory can be provided.

Additionally, the embodiment can provide a method for finding SCC (single cell correction) codes.

### BRIEF DESCRIPTION OF THE DRAWING

The accompanying drawings, which are included to provide a further understanding of the present disclosure and constitute a part of the detailed description, illustrate embodiments of the present disclosure and serve to explain technical features of the present disclosure together with the description.

FIG. 1 is a block diagram for explaining a memory chip for correcting aligned errors according to one embodiment.

FIG. 2 is an example diagram of a parity check matrix according to the embodiment.

FIG. 3 is a flowchart of error correction code generation according to the embodiment.

FIG. 4(a) shows a portion of a parity check matrix including an identity matrix. FIG. 4(b) shows an example of a parity check matrix being generated. FIG. 4(c) shows an example of a completed parity check matrix.

FIGS. 5(a) and 5(b) show tables comparing the performance of comparative examples and the embodiment.

### DETAILED DESCRIPTION

In describing the embodiments in this specification, detailed descriptions of known related technologies may be omitted if it is determined that they may unnecessarily obscure the subject matter of this specification. Also, the terms used in this specification may vary depending on the user's or operator's intention or practice, considering their functions in the embodiments. Therefore, their definitions should be determined based on the overall content throughout this specification. Words used in the singular form may include the plural form. In this description, terms like “include” or “comprise” are used to specify characteristics, numbers, steps, operations, elements, parts, or combinations thereof, but should not be understood as excluding the existence or possibility of one or more other characteristics, numbers, steps, operations, elements, parts, or combinations thereof that are not explicitly stated.

Terms like “first,” “second,” etc. may be used to describe various components, but the components should not be limited by these terms. These terms are only used to distinguish one component from another. An expression in singular form should be understood to include plural forms unless clearly indicated otherwise in context.

The term “and/or” is used to indicate any and all combinations of multiple items listed. For example, “A and/or B” means “A,” “B,” or “A and B”—all three possibilities.

When a component is described as being “connected” or “coupled” to another component, it should be understood that while it may be directly connected or coupled to the other component, there may also be intervening components in between.

Hereinafter, specific embodiments of this specification will be described with reference to the drawings. The following detailed description is provided to aid in a comprehensive understanding of the methods, apparatuses, and/or systems described in this specification. However, these are merely examples and this specification is not limited to these.

First, let's define the terms used in this specification.

[symbol]

Original data refers to data intended to be read and written. Error correction code can be used to correct errors when they occur.

Error correction code (ECC) refers to means or technology that protects data by attaching additional data to original data and correcting errors from modifications to the original data when errors occur.

Redundancy bit/parity bit refers to the additional data attached to original data in error correction code.

Codeword refers to data created by attaching additional data to original data.

Encoding refers to the process of creating a codeword by attaching redundancy bits to original data.

Decoding refers to the process of correcting errors from modified data and recovering the original data.

Generator matrix (Gmatrix) refers to a matrix that generates a codeword by attaching additional data to original data.

Parity check matrix (Hmatrix) refers to a matrix that generates syndromes through operations with codewords.

Syndrome refers to a pattern created by operating a codeword with a parity check matrix, where the error location can be determined by comparing the syndrome with columns of the parity check matrix.

MLC (multi-level cell) memory refers to memory where a single cell can have two or more levels. When one cell can store two bits, it becomes 4LC (4-level cell), and when it can store three or more bits, it becomes 8LC (8-level cell) memory.

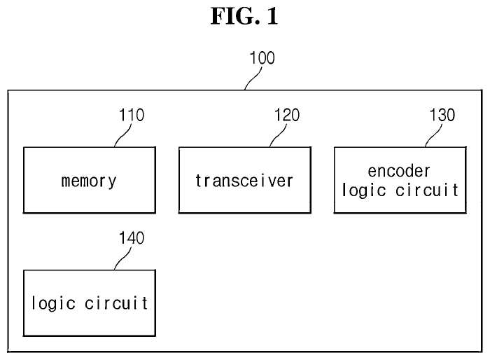

FIG. 1 is a block diagram for explaining a memory chip for correcting aligned errors according to one embodiment.

Referring to FIG. 1, according to the embodiment, the semiconductor chip (100) for correcting aligned errors may include a memory (110), a transceiver (120), an encoder logic circuit (130), and a logic circuit (140). However, the configuration of the semiconductor chip (100) for correcting aligned errors is not limited to this. For example, according to the embodiment, the semiconductor chip (100) for correcting aligned errors may include only the memory (110), encoder logic circuit (130), and logic circuit (140). In this case, since the circuit for memory and error correction exists in the same semiconductor chip, the semiconductor chip (100) for correcting aligned errors may not include a transceiver (120) for receiving data.

The following describes how the semiconductor chip (100) for correcting aligned errors corrects single errors and aligned adjacent errors.

In this specification, for convenience of explanation, the semiconductor chip (100) for correcting aligned errors is described as an example where the memory (110), encoder logic circuit (130), and logic circuit (140) are implemented as a single chip, but is not limited to this. That is, according to the embodiment, the memory (110) chip and a separate control chip may be implemented as a memory system, where the control chip may include the encoder logic circuit (130) and logic circuit (140).

Here, the memory (110) may include random access memory, and can be used as computer's main memory, temporary loading of application programs, temporary storage of data, etc. being a memory that can both read stored information and store other information. Also, the random access memory may include DRAM, SRAM, MRAM, etc.

Data stored in the memory (110) may be binary data having values of 0 or 1. Additionally, the memory (110) can acquire data to be stored and perform operations of writing data to or reading from the memory (110). For this purpose, the random access memory may include a cell array, core, peripheral circuits, etc.

When data stored in the memory (110) becomes modified, the semiconductor chip (100) can restore the modified data using a pre-generated aligned error correction code.

The aligned error correction code may include a generator matrix for encoding and a parity check matrix for error detection. The method of generating the aligned error correction code will be described later.

Additionally, the semiconductor chip (100) can acquire data to be stored in the memory (110) from an external device distinct from the memory (110). Here, the external device may be a device that transmits data to be stored in the memory (110). For example, the external device may be a CPU (Central Processing Unit) including a memory controller.

The transceiver (120) performs communication with the external device and can transmit data to or receive data from the external device. Here, any known method can be used for how the transceiver (120) performs communication with the external device.

Since data may become modified during the communication process while transmitting and receiving data with the external device through the transceiver (120), the semiconductor chip (100) can restore the modified data using the aligned error correction code.

The encoder logic circuit (130) acquires data and encodes the acquired data by multiplying it with the generator matrix of the pre-generated aligned error correction code. The encoded data can be stored in the memory (110), and according to the operating environment of the memory (110), the encoded data may become modified.

Here, the operating environment of the memory (110) may include at least one of row-hammering, process defects, and large leakage current due to high temperature.

Here, row-hammering refers to an operating environment where bit-flips occur causing 0 and 1 to be reversed by affecting memory adjacent to the corresponding memory row when electrical interference occurs as the same row is repeatedly accessed. Additionally, process defects refer to an operating environment where bit-flips occur in stored data due to defects occurring in the memory's design and manufacturing process. Also, large leakage current due to high temperature refers to an operating environment where bit-flips occur in stored data due to large leakage current occurring from high temperature in the memory.

However, the memory's operating environment is not limited to the conditions described above, and includes any known environments where data stored in memory (110) can become modified.

The logic circuit (140) acquires the data modified by the memory's (110) operating environment and corrects single or multiple errors within a single cell of the modified data using the error correction code's parity check matrix.

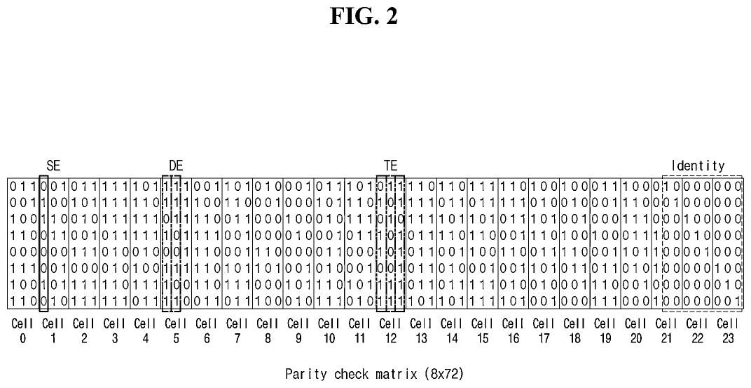

FIG. 2 is an example diagram of the parity check matrix according to the embodiment.

Error correction using the embodiment's error correction code can be called single cell correction (SCC). The following describes SCC used in 8LC memory as an example.

The SCC code used in 8LC memory consists of 64 bits of original data and 8 bits of redundancy. This code can correct syndromes calculated when single errors, double errors, or triple errors occur within a single cell by comparing them with bitwise exclusive OR of columns in the parity check matrix. FIG. 2 shows an example of an SCC code's parity check matrix that can be used in 8LC memory. When a single error (SE) occurs, the resulting syndrome is 0110_0010, which is the same as the column (solid line) at that bit position. When a double error (DE) occurs, the resulting syndrome is 0011_0010, which is the exclusive OR of the columns (dash-dot line) at those bit positions. Similarly, when a triple error (TE) occurs, the resulting syndrome is 0010_0111, which is the exclusive OR of the columns (dash-double-dot line) at those bit positions. Also, to maintain the systematic code form of the SCC code, the last 8 columns shown in red constitute an identity matrix.

When the parity check matrix is determined in the error correction code, its corresponding generator matrix becomes specifically determined. And through a systematic form generator matrix, each original data is encoded into different codewords. In conclusion, the error correction code can be represented by the parity check matrix. In the embodiment, the parity check matrix should be defined to have the following conditions, and FIG. 2 is an example of this. First, all columns must be non-zero. Second, all columns must be different from each other. Third, any exclusive OR of columns within any single cell must be different from each other and different from all columns. The embodiment utilizes a parity check matrix having these conditions.

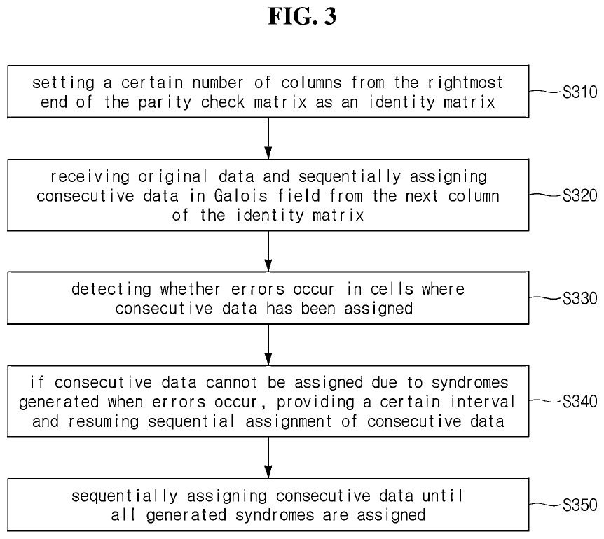

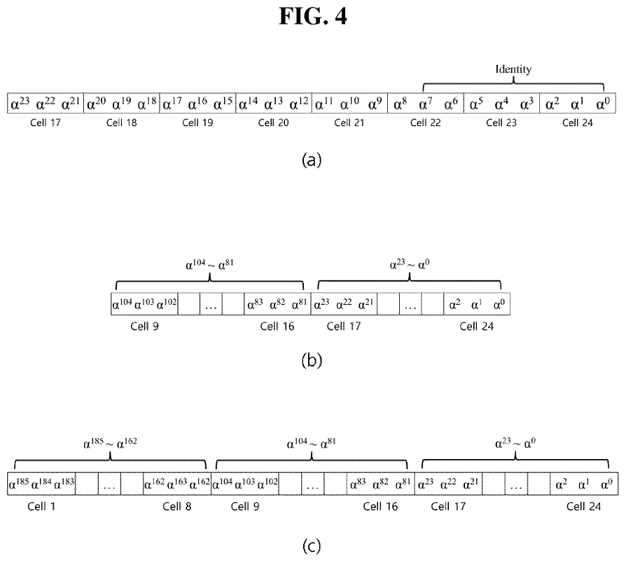

FIG. 3 shows a flowchart of error correction code generation according to the embodiment. FIG. 4(a) shows a portion of a parity check matrix including an identity matrix. FIG. 4(b) shows an example of a parity check matrix being generated. FIG. 4(c) shows an example of a completed parity check matrix.

For example, the embodiment's error correction code can be performed by an engineer.

Referring to FIG. 3, the embodiment's error correction code includes: setting a certain number of columns from the rightmost end of the parity check matrix as an identity matrix (S310); receiving original data and sequentially assigning consecutive data in Galois field from the next column of the identity matrix (S320); detecting whether errors occur in cells where consecutive data has been assigned (S330); if consecutive data cannot be assigned due to syndromes generated when errors occur, providing a certain interval and resuming sequential assignment of consecutive data (S340); and sequentially assigning consecutive data until all generated syndromes are assigned (S350).

Setting a certain number of columns from the rightmost end of the parity check matrix as an identity matrix (S310) is the step of setting, for example, 8 columns from the rightmost position of the parity check matrix as an identity matrix.

Receiving original data and sequentially assigning consecutive data in Galois field from the next column of the identity matrix (S320) is the step of receiving, for example, an arbitrary primitive polynomial and sequentially assigning consecutive elements in the Galois field to cells from the column immediately left of the identity matrix.

FIG. 4(a) shows elements of Galois fields assigned to the parity check matrix for the primitive polynomial x8+x4+x3+x2+1. It can be confirmed that consecutive elements are sequentially assigned from the column immediately left of the identity matrix located on the right.

Detecting whether errors occur in cells where consecutive data has been assigned (S330) is the step of detecting whether there exists a syndrome that is generated when single errors, double errors, or triple errors occur in cells where elements have already been assigned.

If consecutive data cannot be assigned due to syndromes generated when errors occur, providing a certain interval and resuming sequential assignment of consecutive data (S340) is the step of providing a certain interval and resuming assignment of consecutive elements when consecutive elements can no longer be assigned to the remaining cells due to generated syndromes. Providing a certain interval and resuming assignment of consecutive elements can be referred to as providing a certain stride and resuming assignment of consecutive elements.

Referring to FIG. 4(b), when trying to assign α24, α25, α26 to the 16th cell, the exclusive OR of α0 and α1 from α0, α1, α2 assigned to the 24th cell becomes α25, creating an overlap. In this case, an interval (for example, an interval of 58 was given in FIG. 4(b)) is provided until the cell syndromes no longer overlap, and then consecutive elements are assigned starting from α81.

In the step of sequentially assigning consecutive data until all generated syndromes are assigned (S350), step S340 is repeated until syndromes for all single cell errors are assigned, and if a satisfactory parity check matrix is not found, the process can return to step S320 to select a different primitive polynomial.

FIG. 4(c) shows the completed form of a parity check matrix for a code that can correct all single cell errors in 8LC memory when original data is 64 bits and redundancy bits are 16 bits.

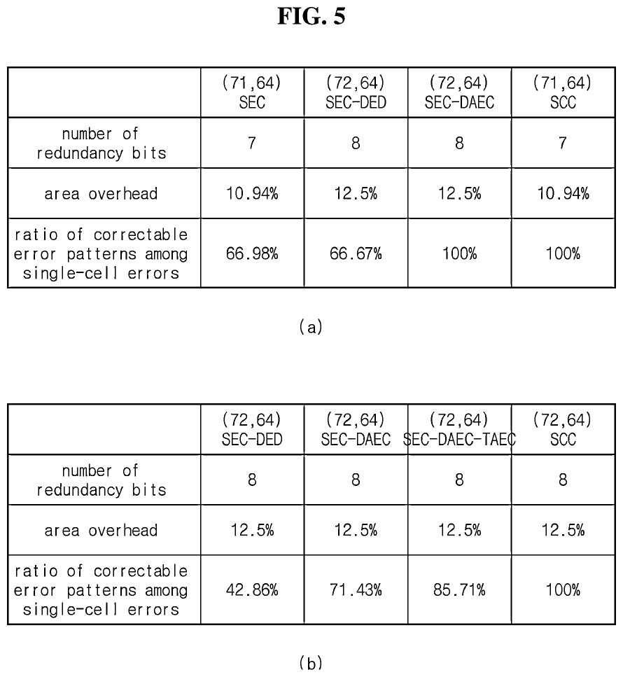

FIGS. 5(a) and 5(b) show tables comparing the performance of comparative examples and the embodiment.

FIG. 5(a) is a comparison table applying error correction codes of comparative examples and the embodiment to 4LC memory, and FIG. 5(b) is a comparison table applying error correction codes of comparative examples and the embodiment to 8LC memory. Referring to FIGS. 5(a) and 5(b), compared to comparative examples SEC (single error correction), SEC-DED (single error correction-double error detection), SEC-DAEC (single error correction-double adjacent error correction), the embodiment's SCC has a low area overhead ratio, minimizing the area occupied by error correction devices in memory while being able to correct all correctable errors among single cell errors.

According to the embodiment's semiconductor chip and semiconductor system for correcting aligned errors, an error correction code can be provided that can correct all single cell errors that can occur in MLC memory while using the same or fewer redundancy bits than existing error correction codes.

Among existing commonly used error correction codes, SEC and SEC-DED use only some syndromes in the total syndrome space to correct single bit errors. In the embodiment, by additionally using non-zero syndromes not used in SEC and SEC-DED for error correction, SCC (single cell correction) that can correct all errors occurring within a single cell is proposed.

In MLC memory, most errors occur on a cell unit basis due to issues like gradually increasing cell resistance over time or wear-out of cell lifetime. Since SCC can correct all single cell errors without using additional redundancy, it can efficiently improve the reliability and durability of MLC memory.

Meanwhile, the embodiments of this specification can be implemented in computer-readable code on computer-readable recording media. The computer-readable recording media include all types of recording devices that can be read by computer systems.

Examples of computer-readable recording media include ROM, RAM, CD-ROM, magnetic tapes, floppy disks, optical data storage devices, etc. Also, the computer-readable recording media can be distributed among networked computer systems and stored and executed as computer-readable code in a distributed manner.

The description of the embodiments provided above is for illustrative purposes, and those skilled in the art would understand that various modifications are possible without changing the technical idea or essential features. Therefore, the embodiments described above should be considered in a descriptive sense rather than a restrictive sense.

The scope of this specification should be determined by the claims described below rather than the detailed description above, and all changes or modified forms derived from the meaning and scope of the claims and their equivalents should be construed as being included in the scope of this specification.

What is claimed is:

1. A semiconductor chip for correcting errors, comprising:
an encoder logic circuit configured to acquire data and encode the acquired data by multiplying a pre-generated error correction code's generator matrix with the acquired data;
a memory configured to receive encoded data, store two or more bits of data in one memory cell, and read out modified data where the encoded data has been modified by operating environment; and
a logic circuit configured to acquire the modified data and correct single or multiple errors within a single cell of the modified data using the error correction code's parity check matrix.

2. The semiconductor chip for correcting errors of claim 1, wherein for 4LC memory, the error correction code has 64 bits of original data bits and 7 check bits, and is configured to correct single or double errors within a single cell.

3. The semiconductor chip for correcting errors of claim 1, wherein for 8LC memory, the error correction code has 64 bits of original data bits and 8 check bits, and is configured to correct single, double, or triple errors within a single cell.

4. The semiconductor chip for correcting errors of claim 1,
wherein the error correction code is generated by:
setting columns corresponding to the number of check bits from the rightmost end of the parity check matrix as an identity matrix,
when the number of check bits is n, selecting one primitive polynomial among multiple primitive polynomials of Galois field (GF) GF(2n),
sequentially assigning consecutive elements in the Galois field defined by the selected primitive polynomial from the left columns of the identity matrix,
when an added column obtained by summing multiple columns within a single cell among the already assigned cells overlaps with an element to be assigned during the sequential assignment of consecutive elements, providing a certain interval and resuming the sequential assignment of consecutive elements, and
generating the error correction code's parity check matrix and generator matrix based on the assignment process.

5. A semiconductor system for correcting errors, comprising:
a memory chip configured to receive encoded data, store two or more bits of data in one memory cell, and read out modified data where the encoded data has been modified by the memory's operating environment;
a control chip configured to control the memory chip, wherein the control chip includes:
an encoder logic circuit configured to acquire data and encode the acquired data by multiplying a pre-generated error correction code's generator matrix with the acquired data and store the encoded data in the memory chip; and
a logic circuit configured to acquire the modified data from the memory chip and correct single or multiple errors within a single cell of the modified data using the error correction code's parity check matrix.

6. The semiconductor system for correcting errors of claim 5,
wherein for 4LC memory, the error correction code has 64 bits of original data bits and 7 check bits, and is configured to correct single or double errors within a single cell.

7. The semiconductor system for correcting errors of claim 5,
wherein for 8LC memory, the error correction code has 64 bits of original data bits and 8 check bits, and is configured to correct single, double, or triple errors within a single cell.

8. The semiconductor system for correcting errors of claim 5,
wherein the error correction code is generated by:
setting columns corresponding to the number of check bits from the rightmost end of the parity check matrix as an identity matrix,
when the number of check bits is n, selecting one primitive polynomial among multiple primitive polynomials of Galois field (GF) GF(2n),
sequentially assigning consecutive elements in the Galois field defined by the selected primitive polynomial from the left columns of the identity matrix,
when an added column obtained by summing multiple columns within a single cell among the already assigned cells overlaps with an element to be assigned during the sequential assignment of consecutive elements, providing a certain interval and resuming the sequential assignment of consecutive elements, and
generating the error correction code's parity check matrix and generator matrix based on the assignment process.

9. A semiconductor chip for correcting errors, comprising:
a transceiver configured to receive modified data where data and encoded data have been modified through communication, and transmit encoded data and decoded data;
an encoder logic circuit configured to multiply the data with a pre-generated error correction code's generator matrix to generate the encoded data; and
a logic circuit configured to correct single or multiple errors within a single cell boundary of the modified data using the error correction code's parity check matrix.

10. The semiconductor chip for correcting errors of claim 9,
wherein for 4LC memory, the error correction code has 64 bits of original data bits and 7 check bits, and is configured to correct single or double errors within a single cell boundary.

11. The semiconductor chip for correcting errors of claim 9,
wherein for 8LC memory, the error correction code has 64 bits of original data bits and 8 check bits, and is configured to correct single, double, or triple errors within a single cell boundary.

12. The semiconductor chip for correcting errors of claim 9,
wherein the error correction code is generated by:
setting columns corresponding to the number of check bits from the rightmost end of the parity check matrix as an identity matrix,
when the number of check bits is n, selecting one primitive polynomial among multiple primitive polynomials of Galois field (GF) GF(2n),
sequentially assigning consecutive elements in the Galois field defined by the selected primitive polynomial from the left columns of the identity matrix,
when an added column obtained by summing multiple columns within a single cell among the already assigned cells overlaps with an element to be assigned during the sequential assignment of consecutive elements, providing a certain interval and resuming the sequential assignment of consecutive elements, and
generating the error correction code's parity check matrix and generator matrix based on the assignment process.
